(19) United States
(12) Patent Application Publication
(10) Pub. No.: US 2007/0096684 A1
(43) Pub. Date: May 3, 2007

(54) Apparatus for controlling electric power for electric vehicle

(76) Inventor: Han Il Kim, Suwon-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/262,207

(22) Filed: Oct. 28, 2005

(51) Int. Cl. H02J 7/00

(52) U.S. Cl. 320/104

(57) ABSTRACT

A control system providing more stable operation of an electric vehicle. From when the ignition switch is turned on to when the power ratchet period is completed, because the reset signal in the state of active “low” is supplied only once, communications between the MCU and apparatuses connected to the MCU can be stable. In addition, because the reset signal in the state of active “low” is not generated even though the ignition switch is turned on during the power ratchet period after the ignition switch is turned off, unnecessary booting does not occur. Therefore, a malfunction between the MCU and a battery management system can be prevented.

### BACKGROUND OF THE INVENTION

1. Field of the Invention

The present invention relates to an apparatus for controlling electric power for an electric vehicle. More particularly, the present invention relates to an engine control apparatus for preventing malfunction of the control unit and battery management system when auxiliary battery power and power from an ignition switch are applied.

2. Description of the Related Art

Control systems of current electric vehicles can experience a number of problems. For example, because a first reset portion of the control circuit can output voltage in the form of an exponential function because of a charging/discharging characteristic of circuit capacitors, a problem can occur in that the width of the control reset signal is unstable. Therefore, the reset signal is not detected consistently by the controller.

In addition, in a case in which the reset signal in a state of active “low” is supplied to the controller, because the reset signal occurs after a long length of time in which the output between capacitors of a first reset portion and the output of capacitors of a second reset portion are added to each other, a problem can occur in that the operating time of the engine control apparatus is delayed.

Therefore, because initializing communication time after resetting becomes long with respect to the torque control unit (TCU), the hybrid control unit (HCU), the battery control unit (BCU), and so on of the electric vehicle, a problem can occur in that rapid response to a request for driving cannot be supplied. In addition, in a case in which the ignition switch is turned on repeatedly during the power ratchet period, a problem can occur in that durability of certain sensors and actuators is reduced. Moreover, in a case in which the power of the main battery is cut off by the ignition switch, a problem can occur in that the voltage from the MCU and BCU are wrongly detected so a self-diagnosis code is output.

The above information disclosed in this Background section is only for enhancement of understanding of the background of the invention, and therefore it may contain information that does not form the prior art that is already known in this country to a person of ordinary skill in the art.

### SUMMARY OF THE INVENTION

Embodiments of the present invention provide an apparatus for controlling electric power for an electric vehicle having advantages of stable communication between control apparatuses. An exemplary apparatus for controlling electric power for an electric vehicle according to an embodiment of the present invention includes a stand-by power generating portion for generating stand-by power by utilizing auxiliary battery power applied from an auxiliary battery and outputting a micro control unit (MCU) reset signal for resetting an MCU in a case in which an MCU reset signal output condition exists, an operating power generating portion for generating operating power supplied to a power consuming device by utilizing power applied from the stand-by power generating portion in a case in which an operating power generating condition exists, and an operation control portion for operating to form the MCU reset signal output condition and the operating power generating condition on the basis of an ignition switch signal and a main relay signal, wherein the operation control portion operates to form the MCU reset signal output condition only when the ignition switch is turned on in a state in which the main relay signal is in an off state, and wherein the operation control portion operates to form the operating power generating condition in a case in which at least one of the main relay signal and the ignition switch signal is in an on state. The stand-by power generating portion comprises a regulator for regulating the stand-by voltage to be constant, and the regulator comprises a reset terminal configured to output an MCU reset signal and a delay terminal for outputting current to the operation control portion. The operating power generating portion comprises a regulator for regulating a voltage of power supplied to the power consuming devices to be constant, wherein the regulator comprises an enable terminal for receiving a signal from the operation control portion and maintains a voltage of an output power to be constant if a signal indicative of existence of the operating power generating condition is input to the enable terminal. The operation control portion comprises a diode unit for receiving the ignition switch signal and main relay signal in parallel and processing said signals, a capacitor electrically connected to the delay terminal of the stand-by power generating portion to be charged by the current output from the delay terminal, a differential circuit for differentiating a signal output from the diode unit and outputting a differentiated signal, and a transistor comprising a base terminal for receiving the signal output from the differential circuit, a collector terminal connected to the capacitor, and an emitter terminal connected to a ground, and discharging the current of the capacitor by being turned on by the signal output from the differential circuit. The differential circuit temporarily turns on the transistor on the basis of the signal transmitted from the diode unit in a case in which the reset signal output condition has occurred. A diode is connected to the base terminal of the transistor of the operation control portion so as to prevent a negative edge of the signal output from the differential circuit from being applied to the transistor. The regulator generates the MCU reset signal until the capacitor is recharged by the current output from the delay terminal, in a case in which the current of the capacitor is discharged.

### BRIEF DESCRIPTION OF THE DRAWINGS

FIG. 1 is a schematic drawing illustrating a power control apparatus of an electric vehicle according to an exemplary embodiment of the present invention.

### DETAILED DESCRIPTION OF THE EMBODIMENTS

An embodiment of the present invention will hereinafter be described in detail with reference to the accompanying drawings.

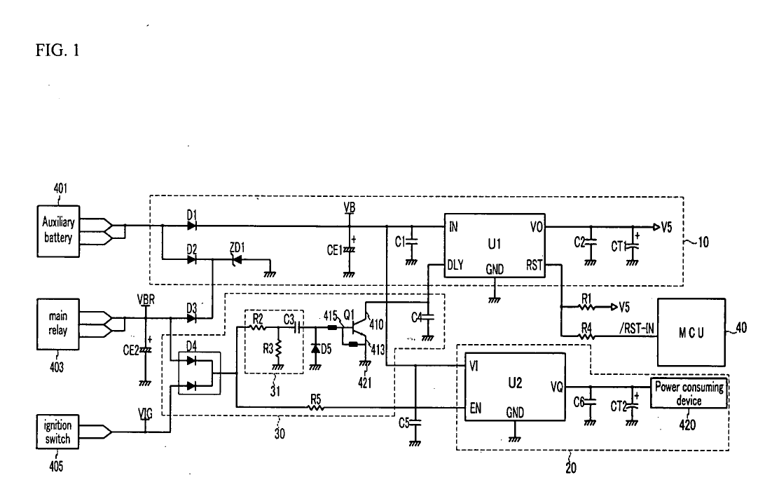

As shown in FIG. 1, according to an exemplary embodiment of the present invention, an electric power control apparatus of an electric vehicle includes a stand-by power generating portion 10, an operating power generating portion 20, and an operation control portion 30. The stand-by power generating portion 10 generates stand-by power by utilizing auxiliary battery power applied from an auxiliary battery 401, and outputs a micro control unit (MCU) reset signal for resetting an MCU 40 in a case in which an MCU reset signal output condition exists.

The term MCU used in an exemplary embodiment of the present invention generally refers to a control unit including a central processing unit (CPU). The CPU may include a processor, memory and associated hardware, software and/or firmware as may be selected and programmed by a person of ordinary skill in the art based on the teachings of the present invention.

The operating power generating portion 20 generates operating power supplied to a power consuming device 420 by utilizing power applied from the stand-by power generating portion 10 in a case in which an operating power generating condition exists.

The operation control portion 30 operates to form the MCU reset signal output condition and the operating power generating condition on the basis of an ignition switch signal and a main relay signal, wherein the operation control portion operates to form the MCU reset signal output condition only when the ignition switch is turned on when the main relay signal is in an off state, and wherein the operation control portion operates to form the operating power generating condition in a case in which at least one of the main relay signal and the ignition switch signal is in an on state.

The stand-by power generating portion 10 includes a regulator U1 which regulates stand-by voltage to be constant, and the reset signal is for booting the MCU 40. More particularly, the reset signal output condition is a case in which the ignition switch signal is detected when a signal from the main relay 403 does not exist. In addition, the operating power generating condition is a case in which at least one signal of the main relay signal or the ignition switch signal is input to the MCU.

A detailed description of the operation of the operation control portion 30 on the basis of reset signal output condition and operating power generating condition is given later.

In a case in which the power of the auxiliary battery 401 is supplied, the regulator U1 of the stand-by power generating portion 10 generates the stand-by power and supplies the power to respective control units. According to an exemplary embodiment of the present invention, the stand-by power is realized as 5 volts (V).

As also shown in FIG. 1, the stand-by power is supplied through terminal V5, and the respective control units are realized as elements, for example, a memory of the control unit which is always turned on.

The regulator U1 includes a reset terminal RST configured to output the MCU reset signal, and a delay terminal DLY. In addition, the regulator U1 may include a reset signal generator. The reset signal generator generates a reset signal in the regulator U1.

When the power of the auxiliary battery 401 is initially supplied, in a state in which the stand-by power is output, the regulator U1 outputs a reset signal in a state of active “low” through the reset terminal RST and transmits the signal to the MCU 40 through the resistor R4.

In addition, the regulator U1 outputs current to the operation control portion 30 through delay terminal DLY. More particularly, the regulator U1 outputs the current and charges a capacitor C4 of the operation control portion 30. At that point, if the capacitor C4 is fully charged, the regulator U1 transmits a reset signal in a state of an active “high” output from the reset terminal to the MCU 40 RST through a resistor R4.

The reset signal in the state of active “low” is for booting the MCU 40 which is generated at the reset signal output condition, and the reset signal in the state of active “high” is for maintaining an operation of the MCU 40 which is generated at the operating power generating condition.

The operating power generating portion 20 includes the regulator U2. The regulator U2 regulates a voltage of the power which is supplied to the power consuming devices 420 to be constant, and the power consuming device 420 is connected to the VCC terminal VCC. Power consuming devices 420 are realized as elements that are turned on/off corresponding to the on/off of the ignition switch.

The regulator U2 includes an enable terminal EN for receiving a signal from the operation control portion 30, and it maintains a voltage of an output power to be constant if a signal indicative of existence of the operating power generating condition is input to the enable terminal EN. That is, the voltage of the auxiliary battery 401 is applied to an input terminal VI of the regulator U2, and the ignition switch signal and the main relay signal are input to the enable terminal EN of the regulator U2.

The regulator U2 maintains the power of 5V on the basis of the input signal until an end of the power ratchet period such that the regulator U2 prevent a malfunction of sensors and actuators related to the EMS.

The power ratchet period is a period corresponding to the operating power generating condition of an engine control unit connected to the main relay 403, and it is a period of from 5 to 8 seconds in which the engine control unit is left on after the ignition switch signal is detected to change from on to off.

The operation control portion 30 includes a diode unit D4, a capacitor C4, a differential circuit 31, and a transistor Q1. The diode unit D4 receives the ignition switch signal and main relay signal in parallel and processes said signals. The capacitor C4 is electrically connected to the delay terminal of the stand-by power generating portion 10, to be charged by the current output from the delay terminal DLY. The differential circuit 31 differentiates a signal output from the diode unit D4 and outputs the differentiated signal.

The transistor Q1 includes a base terminal 415 for receiving the signal output from the differential circuit 31, a collector terminal 410 connected to the capacitor C4, and an emitter terminal 413 connected to a ground 421. The transistor Q1 discharges the current of the capacitor C4 by being turned on by the signal output from the differential circuit 31. According to an exemplary embodiment of the present invention, the diode unit D4 is realized as an OR gate.

Therefore, if one or more signals of the ignition switch signal or the main relay signal is input to the diode unit D4, the diode unit D4 generates a signal. The signal generated in the diode unit D4 is transmitted to the enable terminal EN of the operating power generating portion 20, and is simultaneously transmitted to the differential circuit 31 including resistors R2 and R3 and a capacitor C3. That is, the operating power generating portion 20 supplies the power to the power consuming device 420 on the basis of the signal transmitted from the diode unit D4 to the operating power generating portion 20.

In the case in which the reset signal output condition occurs, the differential circuit 31 temporarily turns on the transistor Q1 on the basis of the signal transmitted from the diode unit D4.

The signal of the diode unit D4 transmitted to the differential circuit 31 is selectively output to the base terminal 415 of the transistor Q1 by the differential circuit 31. That is, the differential circuit 31 outputs the signal only in a case in which the change in the signal transmitted from the diode unit D4 exists. In another words, the signal output from the diode unit D4 changes if the ignition switch 405 is turned on only when both the main relay 403 and the ignition switch 405 are off, i.e., the reset signal output condition occurs. At that time, the differential circuit 31 outputs the signal. In this case, the signal is input to the base terminal 415 of the transistor Q1 and the transistor Q1 is turned on.

The signals generated in the differential circuit 31 include a positive edge and a negative edge. The transistor Q1 is temporarily turned on by the positive edge, and the negative edge is prevented by a diode D5 connected to the base terminal 415 of the transistor Q1. Therefore, damage to the transistor Q1 can be prevented.

Operation of the power control apparatus according to an exemplary embodiment of the present invention is described hereinafter.

If an initial power of the auxiliary battery 401 is supplied, that is, the auxiliary battery 401 is connected, the regulator U1 of the stand-by power generating portion 10 outputs the power of the auxiliary battery 401 supplied through a diode DI as a stand-by power. The stand-by power is realized as a 5V power and is output through an output terminal Vo.

At that time, the regulator U1 outputs the reset signal in the state of active “low” through the reset terminal RST, and the reset signal is applied to the MCU 40 through the resistor R4. Simultaneously, the regulator U1 charges the capacitor C4 of the operation control portion 30 by outputting the current through the delay terminal DLY.

If an equilibrium between a level of a charge voltage and an output current level by completing the charge of the capacitor C4 exists, the regulator U1 outputs the reset signal in the state of active “high” and it is applied to the MCU 40.

At that time, there is no signal output from the main relay 403 or the ignition switch 405, and if the ignition switch 405 is then turned on, a signal of the ignition switch 405 to the diode unit D4 is supplied and the diode unit D4 transmits the signal to the differential circuit 31.

Then, because a positive signal (positive edge) output from the differential circuit 31 is input to the base terminal 415 of the transistor Q1, the transistor Q1 is temporarily turned on.

At that time, the regulator U1 of the stand-by power generating portion 10 outputs and supplies the reset signal in the state of active “low” to the MCU 40 in response to which the charge of the capacitor C4 connected to the collector terminal 410 is discharged to a ground 420.

In a case in which the current of the capacitor C4 is discharged, the regulator U1 generates an MCU reset signal until the capacitor C4 is recharged. If the reset signal in the state of active “low” is transmitted to the MCU 40, the main relay 403 is turned on for supplying the power of the main battery to the sensors and actuators related to the engine control unit.

Then, after the ignition switch 405 is turned off, because the signal of the main relay 403 is transmitted to the diode unit D4 during the power ratchet period, the operating power generating portion 20 supplies the power to the VCC terminal VCC during the power ratchet period.

After the power ratchet period, if the ignition switch 405 is turned on, because the ignition switch signal is applied to the base terminal 415 of the transistor Q1 via the differential circuit 31, the current charged in the capacitor C4 is discharged.

The regulator U1 generates the MCU reset signal until the capacitor C4 is recharged by the current output from the delay terminal DLY, in a case in which the current of the capacitor C4 is discharged.

Therefore, after the power ratchet period is completed, if the ignition switch 405 is turned on just once, a reset signal having a square wave identical to the signal generated when the auxiliary battery 401 is connected is applied to the MCU 40.

As described above, according to an exemplary embodiment of the present invention, from the time the ignition switch 405 is turned on to when the power ratchet period is completed, because the reset signal in the state of active “low” is supplied only once, communications between the MCU 40 and apparatuses connected to the MCU 40 can be stable.

In addition, because a reset period and a waveform are constantly maintained as the square wave under both auxiliary battery power and the power from the ignition switch, a communication starting time is constantly realized. Therefore, stable control can be realized.

In addition, because the reset signal in the state of active “low” is not generated even though the ignition switch is turned on during the power ratchet period after the ignition switch is turned off, unnecessary booting does not occur. Therefore, a malfunction between the MCU and a battery management system can be prevented. Furthermore, because the circuit is simplified, manufacturing costs can be reduced in addition to the reduction in malfunctions.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for controlling electric power of an electric vehicle, comprising:
a stand-by power generating portion for generating stand-by power utilizing auxiliary battery power from an auxiliary battery and outputting a micro control unit (MCU) reset signal for resetting an MCU in a case in which an MCU reset signal output condition exists;
an operating power generating portion for generating operating power supplied to a power consuming device utilizing power applied from the stand-by power generating portion in a case in which an operating power generating condition exists; and
an operation control portion for generating the MCU reset signal output condition and the operating power generating condition on the basis of an ignition switch signal and a main relay signal,
wherein the operation control portion generating the MCU reset signal output condition only when the ignition switch is turned on in a state in which the main relay signal is in an off state, and
wherein the operation control portion generating the operating power generating condition in a case in which at least one of the main relay signal and the ignition switch signal is in an on state.

2. The apparatus of claim 1, wherein the stand-by power generating portion comprises a regulator for regulating the stand-by voltage to be constant, and wherein the regulator comprises:
a reset terminal configured to output an MCU reset signal; and
a delay terminal outputting current to the operation control portion.

3. The apparatus of claim 1, wherein the operating power generating portion comprises a regulator for regulating voltage of power supplied to the power consuming devices to be constant, and wherein said regulator comprises an enable terminal receiving a signal from the operation control portion and maintaining voltage of an output power to be constant if a signal indicative of existence of the operating power generating condition is input to the enable terminal.

4. The apparatus of claim 2, wherein the operation control portion comprises:
a diode unit for receiving the ignition switch signal and main relay signal in parallel and processing said signals;
a capacitor electrically connected to the delay terminal of the stand-by power generating portion to be charged by the current output from the delay terminal;
a differential circuit for differentiating a signal output from the diode unit and outputting a differentiated signal; and
a transistor comprising a base terminal for receiving the signal output from the differential circuit, a collector terminal connected to the capacitor, and an emitter terminal connected to a ground, said transistor discharging the current of the capacitor by being turned on by the signal output from the differential circuit.

5. The apparatus of claim 4, wherein the differential circuit temporarily turns on the transistor on the basis of the signal transmitted from the diode unit in a case in which the reset signal output condition has occurred.

6. The apparatus of claim 4, wherein a diode is connected to the base terminal of the transistor of the operation control portion so as to prevent a negative edge of the signal output from the differential circuit from being applied to the transistor.

7. The apparatus of claim 4, wherein the regulator generates the MCU reset signal until the capacitor is recharged by the current output from the delay terminal, in a case in which the current of the capacitor is discharged.

8. An apparatus for power control in an electric vehicle, comprising:
a stand-by power generation portion configured to output a control unit reset signal in response to a reset signal output condition;
an operating power generation portion configured to supply operating power to a power consuming device by utilizing power from the stand-by power generation portion in response to an operating power generation condition; and
an operation control portion configured to generate the reset signal output condition and the operating power generation condition based on an ignition switch signal and a main relay signal,
wherein the operation control portion generates the reset signal output condition only when the ignition switch is turned on in a state in which the main relay signal is in an off state, and
wherein the operation control portion generates the operating power generation condition when at least one of the main relay signal and the ignition switch signal is in an on state.

9. The apparatus of claim 8, wherein the stand-by power generation portion comprises a regulator providing a constant stand-by voltage, wherein the regulator comprises:
a reset terminal configured to output the control unit reset signal; and
a delay terminal in electrical communication with the operation control portion.

10. The apparatus of claim 8, wherein the operating power generation portion comprises a regulator providing constant voltage to the power consuming devices, wherein the regulator comprises an enable terminal receiving a signal from the operation control portion and said regulator maintains constant output power voltage to in response to a signal indicative of the operating power generation condition being input to the enable terminal.

11. The apparatus of claim 9, wherein the operation control portion comprises:
a diode unit configured to receive the ignition switch signal and main relay signal in parallel and process said signals;
a capacitor electrically connected to the delay terminal of the stand-by power generation portion, said capacitor being charged by current from the delay terminal;
a differential circuit communicating with the diode unit to receive a signal therefrom and outputting a differentiated signal; and
a transistor comprising a base terminal for receiving the signal output from the differential circuit, a collector terminal connected to the capacitor, and an emitter terminal connected to a ground, said transistor discharging the capacitor in response to the signal output from the differential circuit.

12. The apparatus of claim 11, wherein the differential circuit temporarily turns on the transistor on the basis of the signal transmitted from the diode unit when the reset signal output condition has occurred.

13. The apparatus of claim 11, wherein a diode is connected to the base terminal of said transistor to prevent a negative edge of the signal output from the differential circuit from being applied to said transistor.

14. The apparatus of claim 11, wherein said regulator generates the control reset signal until the capacitor is recharged.

15. An apparatus for power control in an electric vehicle, comprising:
a stand-by power generation portion comprising a regulator providing a constant stand-by voltage, said regulator comprising a delay terminal and a reset terminal configured to output a control unit reset signal in response to a reset signal output condition;
an operating power generation portion configured to supply operating power to a power consuming device by utilizing power from the stand-by power generation portion in response to an operating power generation condition; and
an operation control portion configured to generate the reset signal output condition and the operating power generation condition, said control portion comprising
a diode unit configured to receive an ignition switch signal and a main relay signal in parallel and process said signals,
a capacitor electrically connected to the delay terminal of the stand-by power generation portion, said capacitor being charged by current from the delay terminal,
a differential circuit communicating with the diode unit to receive a signal therefrom and outputting a differentiated signal, and
a transistor comprising a base terminal receiving said differentiated signal, a collector terminal connected to the capacitor, and an emitter terminal connected to ground, said transistor discharging the capacitor in response to the signal output from the differential circuit,
wherein the operation control portion generates the reset signal output condition only when the ignition switch is turned on in a state in which the main relay signal is in an off state, and
wherein the operation control portion generates the operating power generation condition when at least one of the main relay signal and the ignition switch signal is in an on state.
